(19) United States
(12) Patent Application Publication
(10) Pub. No.: US 2026/0338242 A1
(43) Pub. Date: Oct. 29, 2026

(54) REDUCED PROFILE BRAKE BACKING PLATE

(71) Applicant: NUCAP Industries Inc., Scarborough (CA)

(72) Inventor: Roman ARBESMAN, Scarborough (CA)

(21) Appl. No.: 19/104,948

(22) PCT Filed: Aug. 21, 2023
(86) PCT No.: PCT/CA2023/051105

§ 371 Date: Feb. 19, 2025

Related U.S. Application Data
(60) Provisional application No. 63/399,596, filed on Aug. 19, 2022.

(51) Int. Cl. F16D 65/092; F16D 69/04

(52) U.S. Cl. CPC F16D 65/092; F16D 69/0408; F16D 2069/0441

(57) ABSTRACT

A brake pad comprising: a backing plate having a backing plate first surface and a plurality of piercing members protruding from the backing plate first surface, the backing plate comprising a first radially curved upper edge and a first radially curved lower edge; and a friction pad assembly having a first surface impaled on the piercing members to secure the friction pad assembly to the backing plate and a friction pad second surface, the friction pad having a second radially curved upper edge and a second radially curved lower edge; and wherein a first distance between the first radially curved upper edge and the first radially curved lower edge is less than a second distance between the second radially curved upper edge and the second radially curved lower edge.

### FIELD

The present disclosure relates generally to brake pads.

### BACKGROUND

Modern vehicle brake systems allow for slowing or stopping movement of a vehicle in a controlled manner. A typical automobile or light truck brake system includes a disc brake assembly for each of the front wheels and either a drum brake assembly or a disc brake assembly for each of the rear wheels. The brake assemblies are simultaneously actuated by hydraulic or pneumatic pressure generated when an operator of the vehicle depresses a brake pedal. The structures of these drum brake assemblies and disc brake assemblies, and their actuators, are well known in the art.

A typical disc brake assembly includes a rotor which is secured to the wheel of the vehicle for rotation therewith. The rotor has a pair of opposed friction faces which are selectively engaged by portions of a caliper assembly. The caliper assembly is slidably supported by pins secured to an anchor plate. This anchor plate is in turn secured to a non-rotatable component of the vehicle, such as the suspended wheel hub. A pair of brake pads (or shoes) are disposed in the caliper assembly on opposite sides of the rotor. These brake pads are operatively connected to one or more hydraulically actuated pistons for movement between a non-braking position, wherein they are spaced apart from the opposed friction plates of the rotor; and a braking position, wherein they are moved into frictional engagement with the opposed friction plates of the rotor. Depressing the brake pedal causes the piston to urge the brake pads from the non-braking position to the braking position, frictionally engaging the friction faces to the rotor and thereby slowing or stopping the rotation of the associated wheel of the vehicle.

Each brake pad is made up of a relatively thick, substantially planar metallic body (the backing plate) to which is attached a cake of friction material (typically a molded composite material) in various ways (including adhesive, rivets, and integral molding into holes or raised features in/on the backing plate).

Backing plates for brake pads are typically made of a single piece of solid steel. The backing plate distributes the force of the caliper piston across the brake pad, and thus it has been believed that a single piece solid backing plate is necessary to provide sufficient strength and rigidity. However, such pieces are very heavy, particularly in large truck applications. This has been a recognized problem in the art. Weight on the sprung or suspended components of a vehicle degrades ride quality and handling, as well as leading to increased fuel consumption and waste of valuable material. There have been attempts to address the weight issue by making a slightly thinner backing plate that is “thickened” in local areas (typically edge perimeter) by embossing. However, the resulting plates are still quite heavy.

### SUMMARY

In one of its aspects, a brake pad comprising:
a backing plate having a backing plate first surface and a plurality of piercing members protruding from the backing plate first surface, the backing plate comprising a first radially curved upper edge and a first radially curved lower edge; and
a friction pad assembly having a friction pad first surface impaled on the piercing members to secure the friction pad assembly to the backing plate and a friction pad second surface, the friction pad having a second radially curved upper edge and a second radially curved lower edge; and wherein a first distance between the first radially curved upper edge and the first radially curved lower edge is less than a second distance between the second radially curved upper edge and the second radially curved lower edge.

In another aspect, a brake pad comprising:
a backing plate having a backing plate first surface and a plurality of piercing members protruding from the backing plate first surface, the backing plate comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation;
a friction pad assembly having a first surface impaled on the piercing members to secure the friction pad assembly to the backing plate and a friction pad second surface, the friction pad having a second radially curved upper edge associated with a second upper curve comprising a second upper radius (r_{2U}) from the first center of rotation; and a second radially curved lower edge associated with a second lower curve comprising a second lower radius (r_{2L}) from the second center of rotation;
wherein the first upper radius (r_{1U}) is less than the second upper radius (r_{2U}) and first lower radius (r_{1L}) is greater than the second lower radius (r_{2L}) such that the first radially curved upper edge and the second radially curved upper edge are separated by a first distance and the first radially curved lower edge and the second radially curved lower edge are separated by a second distance.

In another aspect, a reduced profile backing plate for a brake pad assembly, the reduced profile backing plate comprising:
a backing plate first surface and a plurality of piercing members protruding from the backing plate first surface, wherein a friction pad assembly having a first surface is impaled thereon, and comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation;
wherein the friction pad assembly comprises a second upper curve comprising a second upper radius (r_{2U}) from the first center of rotation, and a second radially curved lower edge associated with a second lower curve comprising a second lower radius (r_{2L}) from the second center of rotation;
wherein the first upper radius (r_{1U}) is less than the second upper radius (r_{2U}) and first lower radius (r_{1L}) is greater than the second lower radius (r_{2L}) such that the first radially curved upper edge and the second radially curved upper edge are separated by a first distance and the first radially curved lower edge and the second radially curved lower edge are separated by a second distance.

In another aspect, a brake pad comprising:
a backing plate having a backing plate first surface, the backing plate comprising a first radially curved upper edge and a first radially curved lower edge; and
a friction pad assembly having a friction pad first surface and a friction pad second surface, the friction pad having a second radially curved upper edge and a second radially curved lower edge; and wherein a first distance between the first radially curved upper edge and the first radially curved lower edge is less than a second distance between the second radially curved upper edge and the second radially curved lower edge; and
wherein the friction pad assembly is affixed to the backing plate first surface.

In another aspect, a reduced profile backing plate comprising:
a backing plate first surface and a plurality of piercing members protruding from the backing plate first surface, the backing plate comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation.

Advantageously, the reduced profile of the backing plate results in a substantially lighter brake pad assembly which leads to substantially less backing plate material, lower manufacturing costs, including operating costs savings and fuel savings for the end-user of a vehicle bearing such a reduced profile backing plate.

### BRIEF DESCRIPTION OF THE DRAWINGS

FIG. 1 shows a brake pad assembly;

FIG. 2a shows a top view of a brake plate;

FIG. 2b shows a perspective view of the brake plate of FIG. 2a; and

FIG. 2c shows another perspective view of the brake of FIG. 2a;

### DETAILED DESCRIPTION

A brake plate is provided that has a substantially planar metallic body. The body has a first friction facing surface and a second caliper facing surface, and a pair of relatively long edges and a pair of relatively short edges. At least one of the long edges has a step-chamfer.

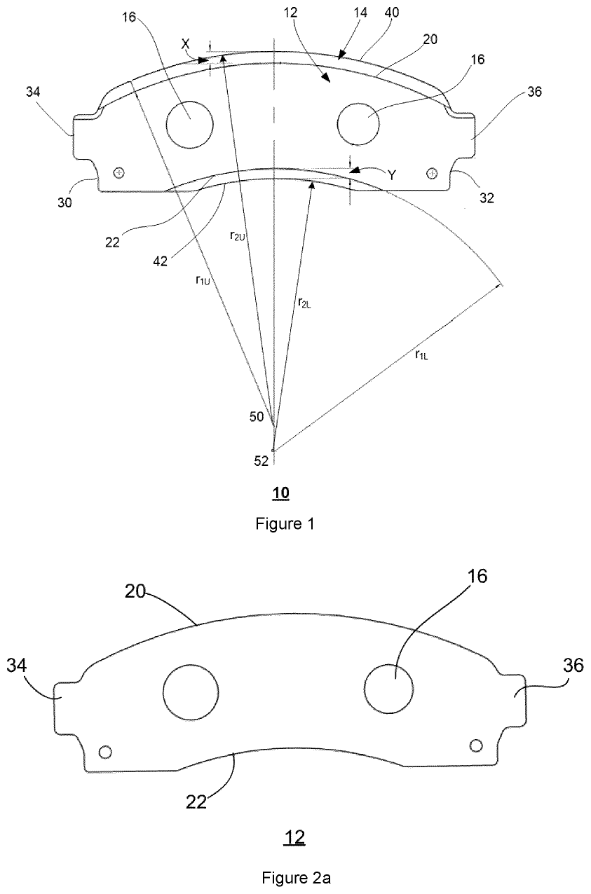

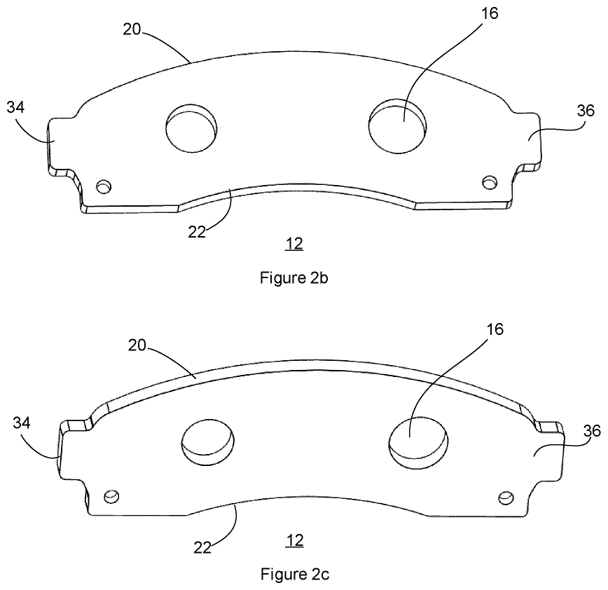

Looking at FIGS. 1, 2a-2c, there is shown a brake pad assembly 10 having a substantially planar body, and comprising a backing plate 12 and a friction pad assembly 14. The backing plate 12 is attached to the friction pad assembly 14 (typically a molded composite material that is secured to the plate 12 with one or a combination of rivets, adhesive, integral-molding, or frictional attachment e.g. NRS™). The plate 12 may be an integrally molded (IM) plate, having integral-molding holes 16 into which friction material flows and hardens to solidify and retain friction material on a surface of the backing plate 12. It will be appreciated that the backing plate 12 may alternatively be a solid body plate (having no integral-molding holes) and may have other friction-attaching surface features, the details of which are known in the art, and are not generally within the scope of the present disclosure. Note that the friction material in any of these methods does not extend all the way out to the edges of the plate. An exposed gap is maintained around the perimeter of the plate.

In one example, the friction pad assembly 14 includes a friction pad and a metal sheet joined to an underside surface of the friction pad. The backing plate 12 includes a backing plate first surface and a plurality of piercing members protruding from the backing plate first surface. The piercing members are forced to bite into and begin to penetrate the core material of the friction pad by a stamping device until the piercing structures have reached maximum penetration and by embedment are locked to the core material.

As used herein, “piercing member” describes any type of nail-or pin-like structure, or hooked or barbed structure, raised on the surface of a material for embedding or piercing. The piercing members may be raised from the surface by carving, gouging or scraping an integral projection from the surface of the material itself. One method of forming such piercing members is described in U.S. Pat. No. 10,335,847 by the present applicant, filed Sep. 8, 2016, which is entitled “Bulk Textured Material Sheeting” and U.S. Pat. No. 11,198,170 by the present applicant, filed May 13, 2019, which is entitled “Bulk Textured Material Sheeting.” The foregoing disclosures are incorporated herein by reference.

The shapes and dimensions of brake backing plates vary widely depending on application. The shape shown in the drawings is merely exemplary of one type for certain models of passenger vehicles, but the invention is not limited to this type/application. Generally, the backing plate 12 comprises two long sides, first radially curved upper edge 20 and first radially curved lower edge 22, and two identical short sides 30, 32. The short sides 30, 32 may have abutments 34, 36, in certain embodiments. The abutments 34, 36 are exposed mounting extensions that are not covered by the friction material and are used for installation and retention of the brake pad 10 in certain caliper designs. The first radially curved upper edge 20 and the first radially curved lower edge 22 of the backing plate 12 may also have projections and other surface features as may be required for particular applications and/or to provide clearance for other mounting or wear sensor hardware, springs, shims, etc.

As can be seen in FIG. 1, a friction pad assembly 14 comprises having a second radially curved upper edge 40 and a second radially curved lower edge 40. In one embodiment, a first distance (X) between the first radially curved upper edge 20 and the first radially curved lower edge 22 is less than a second distance (Y) between the second radially curved upper edge 22 and the second radially curved lower edge 42.

Looking at backing plate assembly 10, the first radially curved upper edge 22 is associated with a first upper curve comprising a first upper radius (r_{1U}) from a first center of rotation 50 and the first radially curved lower edge 24 is associated with a first lower curve comprising a first lower radius (r_{1L}) from a second center of rotation 52. Friction pad assembly 14 comprises a second radially curved upper edge 40 associated with a second upper curve comprising a second upper radius (r_{2U}) from the first center of rotation 50; and a second radially curved lower edge 42 is associated with a second lower curve comprising a second lower radius (r_{2L}) from the second center of rotation 52.

In one example, the first upper radius (r_{1U}) is less than the second upper radius (r_{2U}) and the first lower radius (r_{1L}) is greater than the second lower radius (r_{2L}) such that the first radially curved upper edge 20 and the second radially curved upper edge 40 are separated by first distance (X) and the first radially curved lower edge 22 and the second radially curved lower edge 42 are separated by second distance (Y).

In one example, the first upper curve and the first lower curve have a first common center of rotation 50.

In one example, the second upper curve and the second lower curve have a second common center of rotation 52.

In one example, a first width defined between the first radially curved upper edge 20 and the first radially curved lower edge 22 of the backing plate 12 is less than a second width defined between the second radially curved upper edge 40 and the second radially curved lower edge 42 of the friction pad assembly 14.

In one example, the first distance is about 0.175 inches.

In one example, the second distance is about 0.150 inches.

In one example, the first upper radius (r_{1U}) is about 5.455 inches.

In one example, the first lower radius (r_{1L}) is about 4.244 inches.

The preceding detailed description is presented for purposes of illustration only and not of limitation, and the scope of the invention is defined by the preceding description, and with respect to the attached claims.

1. A brake pad comprising:
a backing plate having a backing plate first surface and a plurality of piercing members protruding from the backing plate first surface, the backing plate comprising a first radially curved upper edge and a first radially curved lower edge; and
a friction pad assembly having a friction pad first surface impaled on the piercing members to secure the friction pad assembly to the backing plate and a friction pad second surface, the friction pad having a second radially curved upper edge and a second radially curved lower edge; and wherein a first distance between the first radially curved upper edge and the first radially curved lower edge is less than a second distance between the second radially curved upper edge and the second radially curved lower edge.

2. The brake pad of claim 1, wherein the first distance is greater than the second distance.

3. The brake pad of claim 1, wherein a first width defined between the first radially curved upper edge and the first radially curved lower edge of the backing plate is less than a second width defined between the second radially curved upper edge and the second radially curved lower edge of the friction pad assembly.

4. A brake pad comprising:
a backing plate having a backing plate first surface and a plurality of piercing members protruding from the backing plate first surface, the backing plate comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation;
a friction pad assembly having a first surface impaled on the piercing members to secure the friction pad assembly to the backing plate and a friction pad second surface, the friction pad having a second radially curved upper edge associated with a second upper curve comprising a second upper radius (r_{2U}) from the first center of rotation; and a second radially curved lower edge associated with a second lower curve comprising a second lower radius (r_{2L}) from the second center of rotation;
wherein the first upper radius (r_{1U}) is less than the second upper radius (r_{2U}) and first lower radius (r_{1L}) is greater than the second lower radius (r_{2L}) such that the first radially curved upper edge and the second radially curved upper edge are separated by a first distance and the first radially curved lower edge and the second radially curved lower edge are separated by a second distance.

5. The brake pad of claim 4, wherein a first width defined between the first radially curved upper edge and the first radially curved lower edge of the backing plate is less than a second width defined between the second radially curved upper edge and the second radially curved lower edge of the friction pad assembly.

6. The brake pad of claim 4, wherein the first distance is greater than the second distance.

7. The brake pad of claim 4, wherein the first upper curve and the first lower curve have a first common center of rotation.

8. The brake pad of claim 4, wherein the second upper curve and the second lower curve have a second common center of rotation.

9. A reduced profile backing plate for a brake pad assembly, the reduced profile backing plate comprising:
a backing plate first surface and a plurality of piercing members protruding from the backing plate first surface, wherein a friction pad assembly having a first surface is impaled thereon, and comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation;
wherein the friction pad assembly comprises a second upper curve comprising a second upper radius (r_{2U}) from the first center of rotation, and a second radially curved lower edge associated with a second lower curve comprising a second lower radius (r_{2L}) from the second center of rotation;
wherein the first upper radius (r_{1U}) is less than the second upper radius (r_{2U}) and first lower radius (r_{1L}) is greater than the second lower radius (r_{2L}) such that the first radially curved upper edge and the second radially curved upper edge are separated by a first distance and the first radially curved lower edge and the second radially curved lower edge are separated by a second distance.

10. The reduced profile backing plate of claim 9, wherein a first width defined between the first radially curved upper edge and the first radially curved lower edge of the backing plate is less than a second width defined between the second radially curved upper edge and the second radially curved lower edge of the friction pad assembly.

11. The reduced profile backing plate of claim 9, wherein the first distance is greater than the second distance.

12. The reduced profile backing plate of claim 9, wherein first distance is about 0.175 inches.

13. The reduced profile backing plate of claim 9, wherein the second distance is about 0.150 inches.

14. The reduced profile backing plate of claim 9, wherein the first upper curve and the first lower curve have a first common center of rotation.

15. The reduced profile backing plate of claim 9, wherein the second upper curve and the second lower curve have a second common center of rotation.

16. The reduced profile backing plate of claim 9, wherein the first upper radius (r_{1U}) is about 5.455 inches.

17. The reduced profile backing plate of claim 9, wherein the first lower radius (r_{1L}) is about 4.244 inches.

18. A brake pad comprising:
a reduced profile backing plate having a backing plate first surface, the backing plate comprising a first radially curved upper edge and a first radially curved lower edge; and
a friction pad assembly having a friction pad first surface and a friction pad second surface, the friction pad having a second radially curved upper edge and a second radially curved lower edge; and wherein a first distance between the first radially curved upper edge and the first radially curved lower edge is less than a second distance between the second radially curved upper edge and the second radially curved lower edge; and
wherein the friction pad assembly is affixed to the backing plate first surface.

19. The brake pad of claim 18, wherein the first distance is greater than the second distance.

20. The brake pad of claim 18, wherein a first width defined between the first radially curved upper edge and the first radially curved lower edge of the backing plate is less than a second width defined between the second radially curved upper edge and the second radially curved lower edge of the friction pad assembly.

21. The brake pad of claim 18, wherein the first radially curved upper edge is associated with a first upper curve comprising a first upper radius (r_{1U}) from a first center of rotation and the first radially curved lower edge is associated with a first lower curve comprising a first lower radius (r_{1L}) from a second center of rotation.

22. The brake pad of claim 21, wherein the second radially curved upper edge is associated with a second upper curve comprising a second upper radius (r_{2U}) from the first center of rotation; and the second radially curved lower edge is associated with a second lower curve comprising a second lower radius (r_{2L}) from the second center of rotation.

23. The brake pad of claim 22, wherein the first upper radius (r_{1U}) is less than the second upper radius (r_{2U}) and first lower radius (r_{1L}) is greater than the second lower radius (r_{2L}).

24. The brake pad of claim 22, wherein a first width defined between the first radially curved upper edge and the first radially curved lower edge of the backing plate is less than a second width defined between the second radially curved upper edge and the second radially curved lower edge of the friction pad assembly.

25. The brake pad of claim 18, wherein the first distance is greater than the second distance.

26. The brake pad of claim 21, wherein the first upper curve and the first lower curve have a first common center of rotation.

27. The brake pad of claim 22, wherein the second upper curve and the second lower curve have a second common center of rotation.

28. A reduced profile backing plate comprising:
a backing plate first surface and a plurality of piercing members protruding from the backing plate first surface, the backing plate comprising a first radially curved upper edge associated with a first upper curve comprising a first upper radius (r_{1U}) from a first center of rotation and a first radially curved lower edge associated with a first lower curve comprising a first lower radius (r_{1L}) from a second center of rotation.
